(19) United States
(12) Patent Application Publication
(10) Pub. No.: US 2011/0317095 A1
(43) Pub. Date: Dec. 29, 2011

(54) SUPPORTING UNIT, SHEET SET, ILLUMINATING DEVICE, AND DISPLAY DEVICE

(75) Inventor: Takaharu Shimizu, Osaka-shi (JP)

(73) Assignee: SHARP KABUSHIKI KAISHA, Osaka-shi, Osaka (JP)

(21) Appl. No.: 13/148,478

(22) PCT Filed: Oct. 29, 2009
(86) PCT No.: PCT/JP2009/068557

§ 371 Date: Aug. 9, 2011

(30) Foreign Application Priority Data
Mar. 4, 2009 (JP) 2009-051157

(51) Int. Cl. G02F 1/13357; F16M 13/00; F21V 7/00; B32B 3/26

(52) U.S. Cl. 349/62; 428/161; 248/346.01; 362/307

(57) ABSTRACT

A supporting unit (11) makes a reflection sheet (41) having a relatively low rigidity sag toward the side surface (13S) of a base section (13) by supporting the reflection sheet (41) on a hem section (15), and at the same time, supports a diffusion sheet (43) having a relatively high rigidity on the leading edge of a shaft section (12).

### TECHNICAL FIELD

The present invention relates to a supporting unit for supporting a sheet, and to a sheet set which is a set of a sheet supported by such a supporting unit and the supporting unit itself. The invention also relates to an illuminating device (such as a backlight unit) provided with a sheet set, and to a display device (such as a liquid crystal display device) provided with such an illuminating device.

### BACKGROUND ART

When a liquid crystal display panel of a non-luminous type is used, a backlight unit (illuminating device) for supplying light to the liquid crystal display panel is provided in a liquid crystal display device. The backlight unit may adopt one of various types of light sources. For example, as a light source, a plurality of fluorescent lamps arranged side by side are provided

In such a case, uneven distribution of light, called a “lamp image,” is observed in the light from the backlight unit. A lamp image denotes uneven distribution of light which makes the linear shapes of fluorescent lamps visible as a result of there being a large difference between the amount of light supplied to about right above the fluorescent lamps and the amount of light supplied to about right above the intervals between the fluorescent lamps.

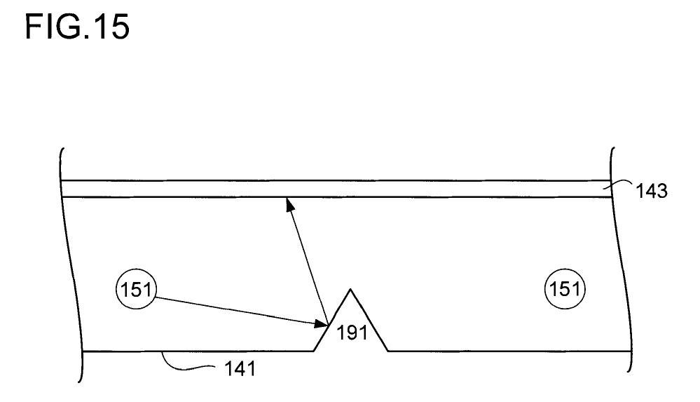

Some backlight units are designed to make the lamp image less visible, one example being the one disclosed in Patent Publication 1 listed below. In this backlight unit, as shown in FIG. 15, between adjacent fluorescent lamps 151, a reflective member 191 having a triangular cross-sectional shape is fitted on a reflective surface 141 (in FIG. 15, the reference sign 143 represents a diffuser sheet).

In this design provided with the reflective member 191, part of the light from the fluorescent lamps 151 is reflected on the reflective member 191, so that light is supplied to about right above the intervals between the fluorescent lamps 151 (see the solid-line arrows). This reduces the difference between the amount of light supplied to about right above the fluorescent lamps 151 and the amount of light supplied to about right above the intervals between the fluorescent lamps 151, and thus makes the lamp image less visible.

### LIST OF CITATIONS

### Patent Literature

Patent Publication 1: JP-A-2002-122863

### SUMMARY OF INVENTION

### Technical Problem

There are many kinds of reflective members like the reflective member 191. To name a few, in one example, a reflective member 191 is formed as a separate piece from a reflective sheet as is conventionally provided; in another example, part of a metal chassis, covered by a reflective sheet, of a backlight unit is raised to form a reflective member 191.

Inconveniently, however, a reflective member 191 formed as a separate piece counts as an extra component, and thus leads to increased cost. On the other band, raising part of a metal backlight chassis requires a modification or the like to a comparatively large mold, and thus leads to increased cost.

The present invention is made to overcome the inconveniences mentioned above, and it is an object of the invention to provide a component that is suitable to suppress, at low cost, uneven distribution of light in the light from an illuminating device, and to provided an illuminating device and a display device provided with such a component.

### Solution to Problem

The component that is suitable to suppress uneven distribution of light in the light from an illuminating device is a supporting unit that supports a sheet. The supporting unit includes a shaft portion and a base portion which supports the shaft portion. In this supporting unit, part of the shaft portion or part of the base portion supports, out of a first sheet (for example, a reflective sheet) and a second sheet (for example, an optical sheet), the first sheet having lower rigidity so as to let the first sheet sag toward the side face of the base portion, and the tip end of the shaft portion supports, out of the first and second sheets, the second sheet having higher rigidity.

When this supporting unit is disposed between adjacent fluorescent lamps in an illuminating device, the fluorescent lamps are located by the side of the sagging part of the first sheet. When the first sheet is a reflective sheet, the light from the fluorescent lamps is reflected on the sagging part of the reflective sheet so as to travel to about right above the intervals between the fluorescent lamps. This reduces the difference between the amount of light supplied to about right above the fluorescent lamps and the amount of light supplied to about right above the intervals between the fluorescent lamps, and thus suppresses uneven light distribution such as a lamp image.

An illuminating device is conventionally provided with a supporting member for supporting an optical sheet. Therefore, when the second sheet is an optical sheet, it can be said that the supporting unit is a modified version of a supporting member that is conventionally provided in an illuminating device. Thus, the illuminating device does not require an increased number of components, and this suppresses an increase in the cost of the illuminating device. Moreover, since the supporting unit is a comparatively small component, its modification can be achieved at comparatively low cost.

It is preferable that the supporting unit, for example when the first sheet includes a hole, support the first and second sheets in the following manner: the shaft portion sticks through the hole in the first sheet so as to support, at its tip end, the second sheet, and the part of the shaft portion or the part of the base portion supports the edge of the hole so as to support the first sheet.

The part of the shaft portion may be its tip end, or may be a first supporting portion which is formed as a protrusion that protrudes from the side face of the shaft portion.

The part of the base portion may be a second supporting portion which is formed as a protrusion that protrudes from the side face of the base portion, or may be a fixing portion which supports the base end of the shaft portion and which is larger than the outer circumference of the base end.

The base portion may support a plurality of such shaft portions. This design helps reduce the number of components, and helps reduce the cost of the illuminating device.

It is preferable that the base portion be increasingly thick toward its bottom end opposite from its end supporting the shaft portion. With this design, the center of gravity of the supporting unit is closer to the base end of the base portion, and thus the first and second sheets are supported more stably.

It is preferable that the shaft portion be increasingly thin toward its tip end. With this design, when the user views, for example, a display device provided with an illuminating device including the supporting unit, the tip end of the shaft portion is less visible.

Also within the scope of the invention is a sheet set that includes: a supporting unit as described above; as the first said sheet, a reflective sheet which reflects received light; and as the second said sheet, an optical sheet which transmits received light.

It is preferable that the reflective sheet be subjected to processing (for example, kiss-cutting or slitting) to allow the reflective sheet to bend along the boundary between the part of the reflective sheet that is supported by the part of the shaft portion or the part of the base portion and the part of the reflective sheet that sags toward the side face of the base portion.

With this design, when the supporting unit is disposed, for example, between adjacent fluorescent lamps in an illuminating device, the reflective sheet easily sags toward the side face of the base portion. This ensures that the fluorescent lamps are located by the side of the sagging part of the reflective sheet, and that part of the light from the fluorescent lamps travels to about right above the intervals between the fluorescent lamps. This suppresses uneven light distribution in the illuminating device.

Also within the scope of the invention is an illuminating device that includes: a sheet set as described above; a chassis to the bottom face of which the base portion of the supporting unit is fitted; and a light source (for example, a linear light source or a point light source) provided between the first and second said sheets to emit light.

Also within the scope of the invention is a display device that includes: an illuminating device as described above; and a display panel to receive the light from the illuminating device.

### ADVANTAGEOUS EFFECTS OF THE INVENTION

According to the present invention, a supporting unit which is a small and hence inexpensive component is provided between adjacent fluorescent lamps so as to let a reflective sheet sag to be located by the side of the fluorescent lamps. Thus, the light reflected from the sagging part of the reflective sheet reaches about right above the intervals between the fluorescent lamps. As a result, the light from the illuminating device is free from uneven light distribution called lamp unevenness. It can thus be said that the supporting unit is a component that can suppress uneven light distribution in an illuminating device at low cost.

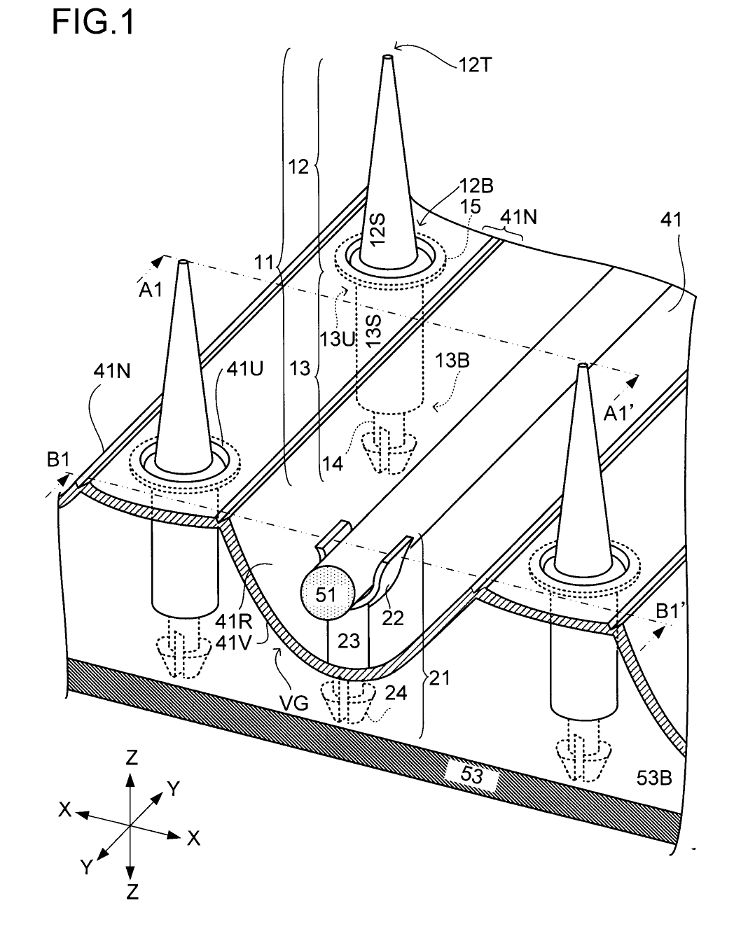

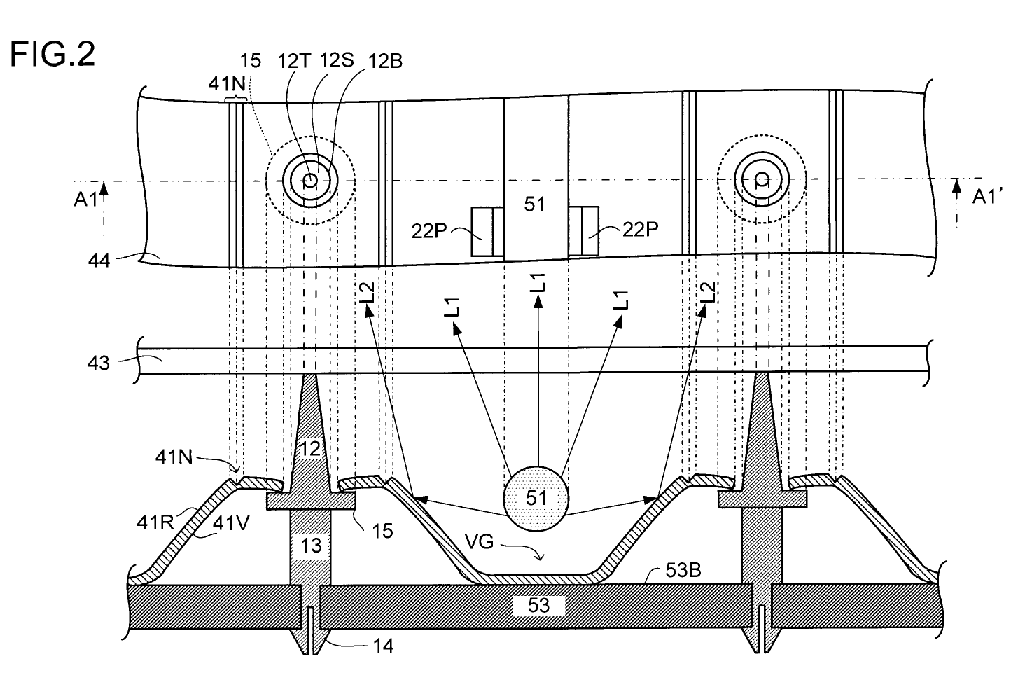

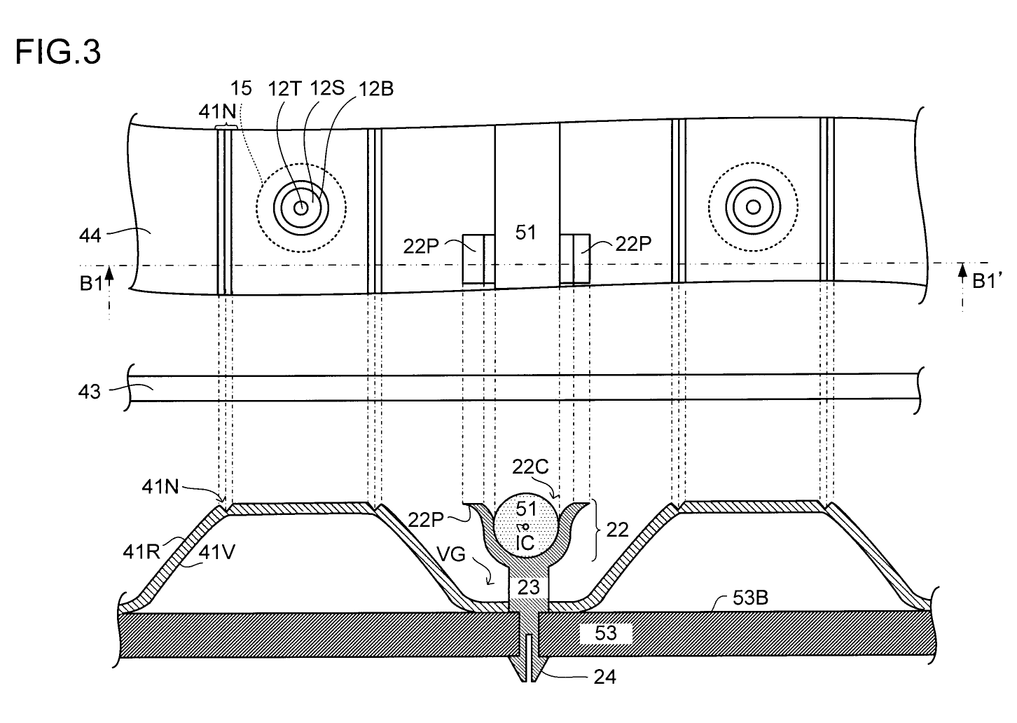

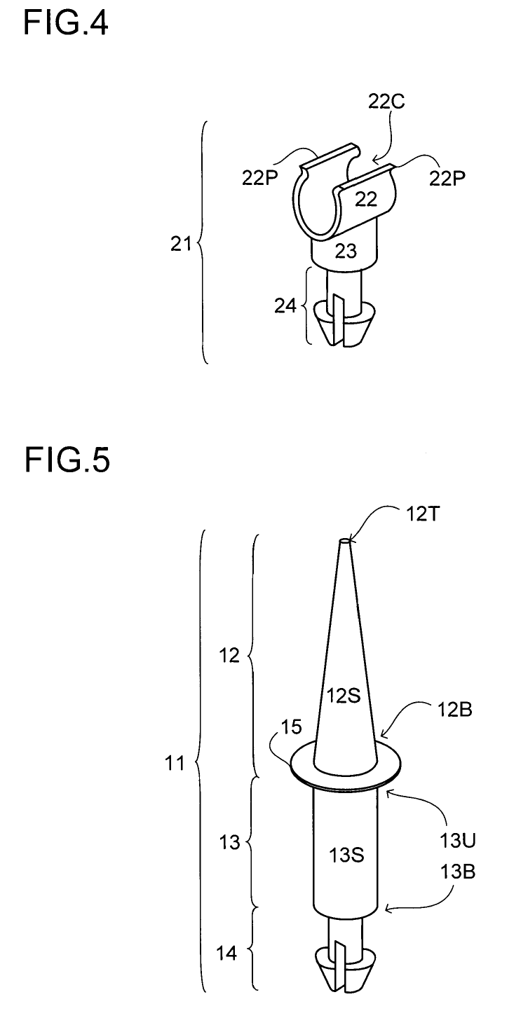

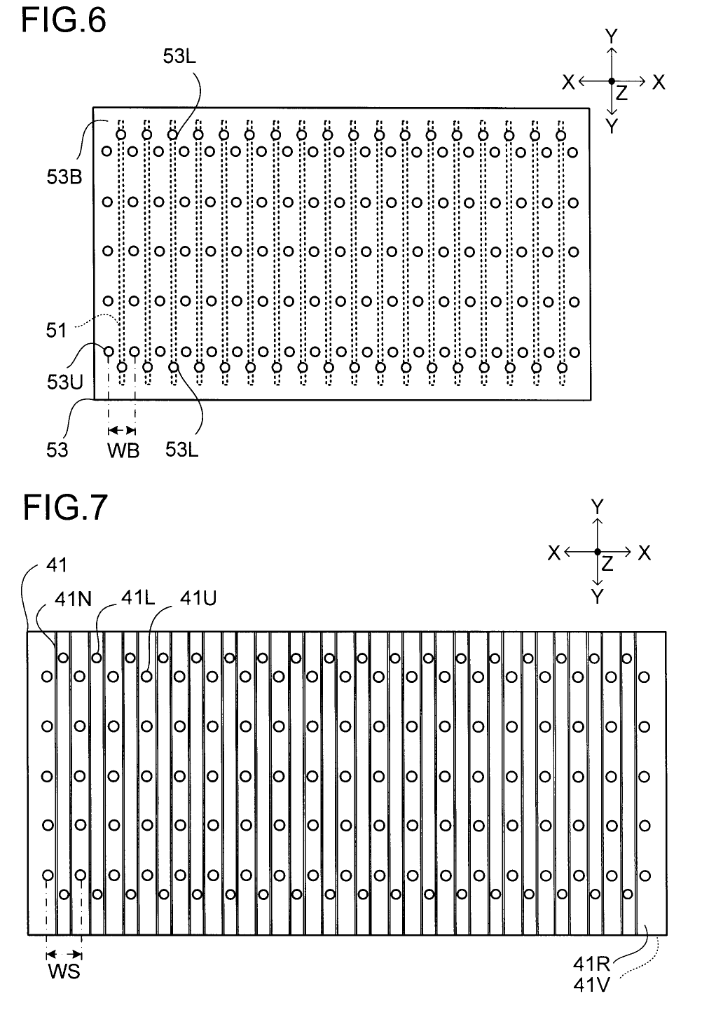

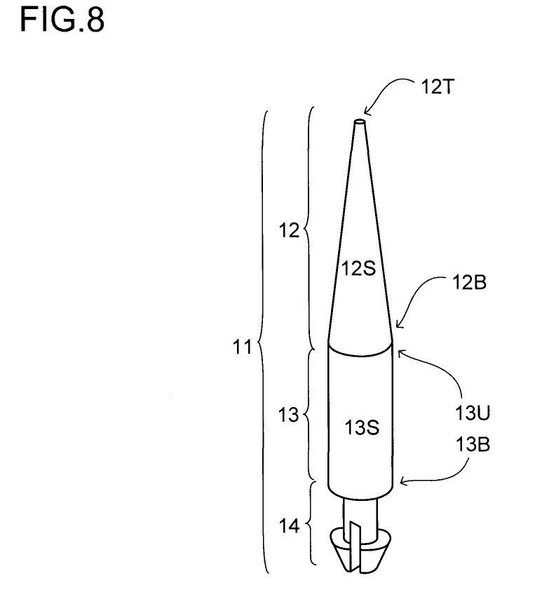

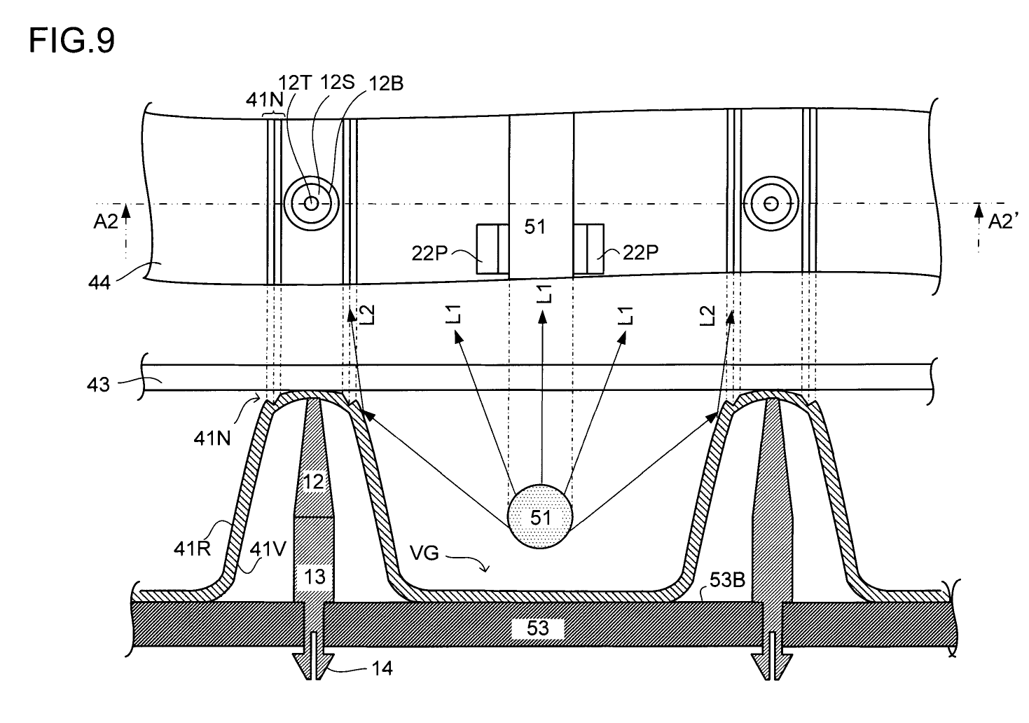

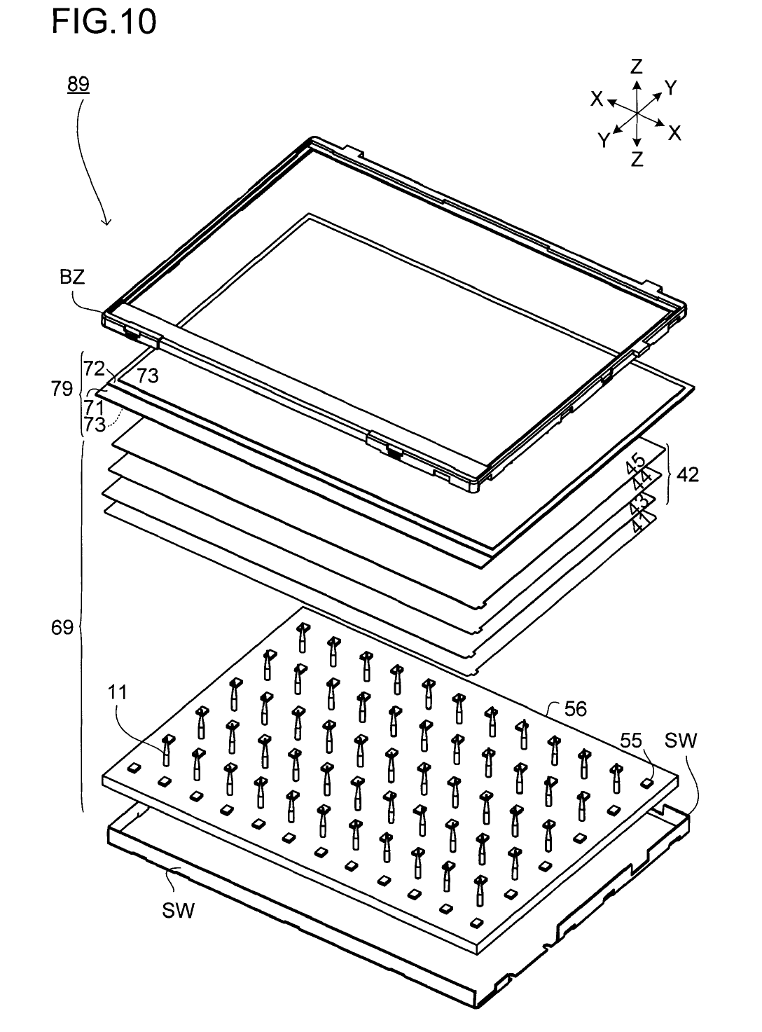

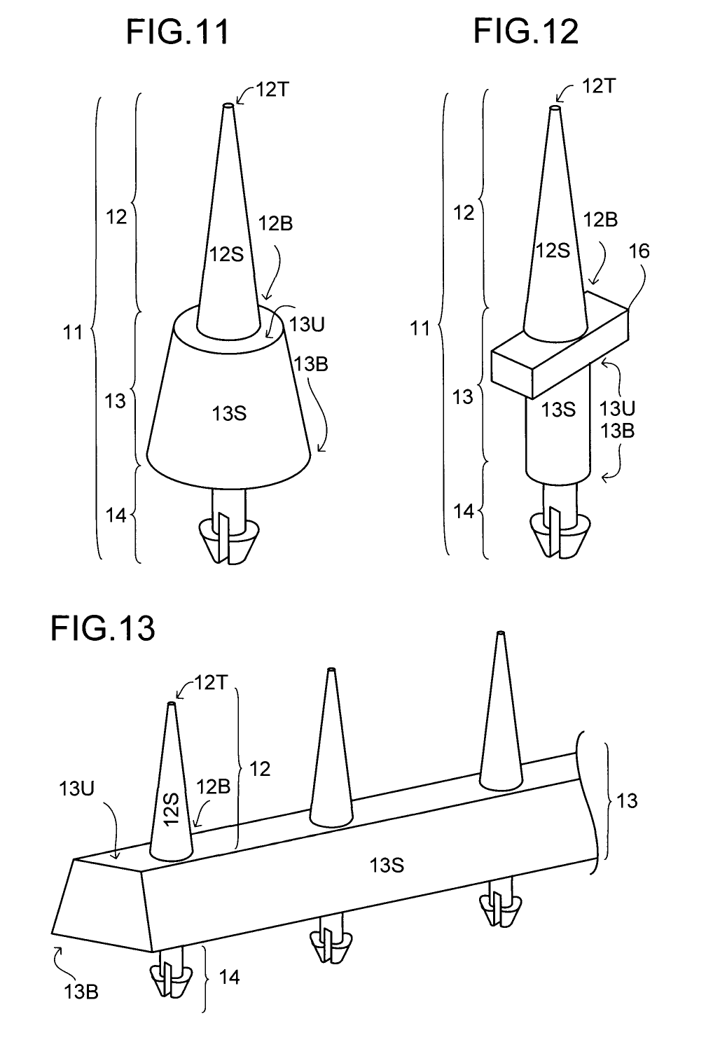

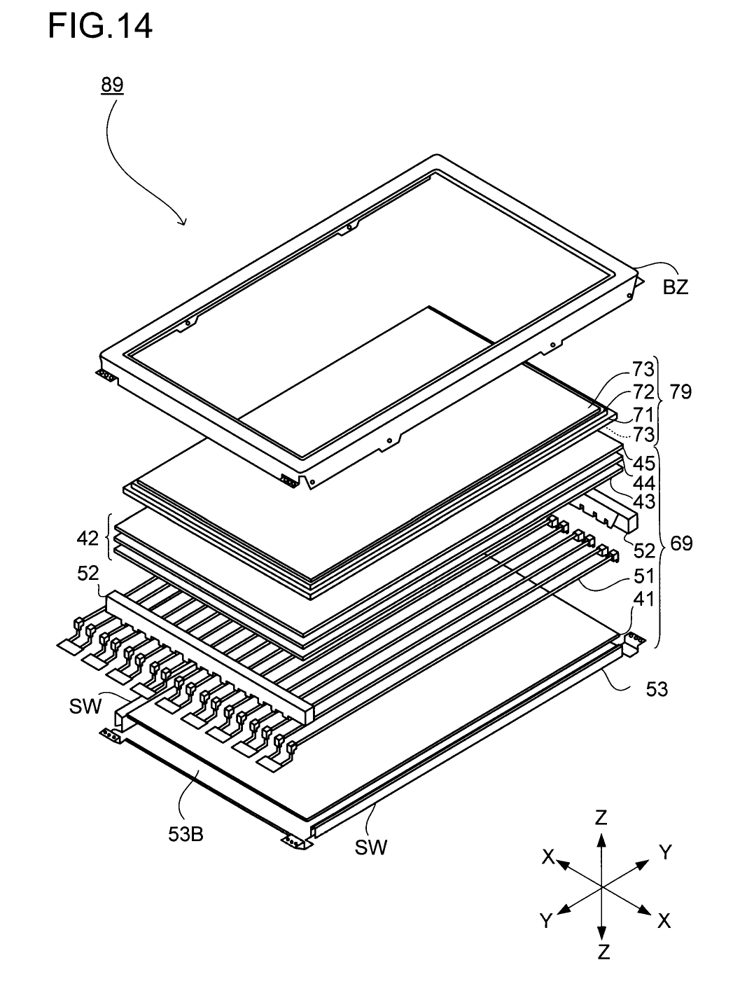

### BRIEF DESCRIPTION OF DRAWINGS

[FIG. 1] is a partial perspective view showing a lamp clip gripping a fluorescent lamp and supporting units supporting a reflective sheet;

[FIG. 2] is a two-view diagram consisting of a plan view showing different members disposed on a backlight chassis and a sectional view cut along line A1-A1′ in the plan view as seen from the direction of arrows;

[FIG. 3] is a two-view diagram consisting of a plan view showing different members disposed on a backlight chassis and a sectional view cut along line B1-B1′ in the plan view as seen from the direction of arrows;

[FIG. 4] is a perspective view of a lamp clip;

[FIG. 5] is a perspective view of a supporting unit;

[FIG. 6] is a plan view of a backlight chassis;

[FIG. 7] is a plan view of a reflective sheet;

[FIG. 8] is a perspective view of a supporting unit;

[FIG. 9] is a two-view diagram showing how the supporting unit in FIG. 8 supports the reflective sheet (the sectional view being one cut along line A2-A2′ in the plan view as seen from the direction of arrows);

[FIG. 10] is an exploded perspective view of a liquid crystal display device;

[FIG. 11] is a perspective view of a supporting unit different from those in FIGS. 5 and 8;

[FIG. 12] is a perspective view of a supporting unit different from those in FIGS. 5, 8, and 11;

[FIG. 13] is a perspective view of a supporting unit different from those in FIGS. 5, 8, 11, and 12;

[FIG. 14] is an exploded perspective view of a liquid crystal display device; and

[FIG. 15] is a sectional view of a conventional backlight unit.

### DESCRIPTION OF EMBODIMENTS

### Embodiment 1

An embodiment (Embodiment 1) of the present invention will be described below with reference to the accompanying drawings. For convenience' sake, hatching and reference signs will occasionally be omitted, in which case reference should be made to other drawings. In the drawings, a black dot represents the direction perpendicular to the plane of paper.

FIG. 14 is an exploded perspective view of a liquid crystal display device 89 as an example of a display device. As shown there, the liquid crystal display device 89 includes a liquid crystal display panel (display panel) 79, a backlight unit (illuminating device) 69, and a bezel BZ.

The liquid crystal display panel 79 is composed of an active matrix substrate 71, which includes switching elements such as TFTs (thin-film transistors), and a counter substrate 72, which faces the active matrix substrate 71, bonded together with a sealing member (not shown). The gap between the two substrates 71 and 72 is filled with liquid crystal (not shown) (in addition, polarizer films 73 and 73 are fitted to the active matrix substrate 71 and the counter substrate 72 so as to sandwich these from opposite sides).

The liquid crystal display panel 79 is of a non-luminous type, and therefore performs its displaying function by receiving the light (backlight) from the backlight unit 69. Thus, making the light from the backlight unit 69 illuminate the entire surface of the liquid crystal display panel 79 as evenly as possible helps improve the display quality of the liquid crystal display panel 79.

The backlight unit 69 includes fluorescent lamps (light sources, linear light sources) 51, lamp holders 52, a backlight chassis 53, a reflective sheet 41, and an optical sheet stack 42 (a diffuser sheet 43 and lens sheets 44 and 45).

Although not shown in FIG. 14, the backlight unit 69 further includes lamp clips 21, which grip the fluorescent lamps 51 and fit them to the backlight chassis 53, and support units 11, which on one hand support the optical sheet stack 42 and on the other hand also support the reflective sheet 41 (see FIG. 1, which will be discussed later).

The fluorescent lamps 51 are linear (bar-shaped, cylindrical, etc.) light sources, and a plurality of them are provided inside the backlight unit 69 (for convenience's sake, however, not all of them are necessarily shown in all the relevant drawings).

The fluorescent lamps 51 may be of any type; they may be, for example, cold cathode lamps or hot cathode lamps. In the following description, the direction in which the fluorescent lamps 51 are arranged side by side will be referred to as X direction, the direction in which the fluorescent lamps 51 extend will be referred to as Y direction, and the direction perpendicular to both X and Y directions will be referred to as Z direction.

The lamp holders 52 are a pair of block-like members, and hold the fluorescent lamps 51 and the optical sheet stack 42. More specifically, the lamp holders 52 support the fluorescent lamps 51, each of the former at a different end of the latter, and thereby permit the fluorescent lamps 51 to be provided in the backlight unit 69. Moreover, the lamp holders 52 support, at their face facing the liquid crystal display panel 79, the diffuser sheet 43, on top of which the lens sheets 44 and 45 are provided; thus, the diffuser sheet 43 and the lens sheets 44 and 45 are provided in the backlight unit 69.

The backlight chassis (chassis) 53 is a housing member having a bottom face 53B and walls (opposite walls) SW and SW, the latter rising from the former and being opposite each other. The backlight chassis 53 houses the fluorescent lamps 51 and other components.

The backlight chassis 53 has holes (chassis holes 53L) for the fitting of lamp clips 21 and holes (chassis holes 53U) for the fitting of support units 11. The chassis holes 53L and 53U will be discussed in detail later.

The reflective sheet 41 is a reflective member which covers the bottom face 53B of the backlight chassis 53. The reflective sheet 41 reflects the light from the fluorescent lamps 51 disposed inside the backlight chassis 53. More specifically, the reflective sheet 41 reflects part of the light emanating radially from the fluorescent lamps 51 (the light traveling radially from each fluorescent lamp 51 as a center) so as to direct it to the open face of the backlight chassis 53.

The reflective sheet 41 is supported by support units 11, which will be discussed later, and as a result sags from place to place. For convenience' sake, these sags are not shown in FIG. 14. The reflective sheet 41 has two kinds of holes 41U and 41L, one kind (sheet holes 41U) corresponding to support units 11, and the other kind (sheet holes 41L) corresponding to lamp clips 21. Details will be discussed later.

The optical sheet stack 42 transmits the light from the fluorescent lamps 51, and includes a diffuser sheet 43 and lens sheets 44 and 45.

The diffuser sheet 43 is a member formed of a resin that has the functions of scattering and diffusing light, examples of such resins including polyethylene terephthalate. The diffuser sheet (optical sheet) 43 is disposed so as to cover the fluorescent lamps 51 arranged side by side on the bottom face 53B of the backlight chassis 53. Thus, when the light from the fluorescent lamps 51 enters the diffuser sheet 43, the light is scattered and diffused so as to distribute evenly across the plane of the sheet.

The lens sheet 44 is, for example, an optical sheet that has the shape of prisms on the sheet surface to narrow the directivity of light, and is disposed so as to cover the diffuser sheet 43. Thus, the lens sheet (optical sheet) 44 condenses the light emanating from the diffuser sheet 43 and thereby increases the luminance.

The lens sheet 45 is disposed so as to cover the lens sheet 44, and is an optical sheet that transmits a light component polarized in one direction and reflects a light component polarized in the direction perpendicular to the direction in which the transmitted polarized light component is polarized. The lens sheet (optical sheet) 45 reflects, for reuse, the polarized component absorbed by the diffuser film 73, and thereby increases the luminance on the liquid crystal display panel 79.

The bezel BZ serves as part of the exterior of the liquid crystal display device 89, and is a member that houses the backlight unit 69 and the liquid crystal display panel 79 disposed on top of the backlight unit 69.

In the backlight unit 69 designed as described above, the fluorescent lamps 51 arranged side by side emit light by being supplied with an alternating-current signal from an inverter (not shown). The light reaches the diffuser sheet 43 directly or after being reflected on the reflective sheet 41. The light that has reached the diffuser sheet 43 then, while being diffused, passes through the lens sheets 44 and 45 so as to leave them as backlight with increased luminance. The backlight then reaches the liquid crystal display panel 79, which displays an image.

Now, how lamp clips 21 and support units 11, which are omitted in FIG. 14, support (hold) the reflective sheet 41 will be described with reference to FIGS. 1 to 7 (the support units 11 along with the reflective sheet and the diffuser sheet 43 may be collectively called a sheet set).

FIG. 4 is a perspective view of a lamp clip 21, and FIG. 5 is a perspective view of a support unit 11. FIG. 6 is a plan view of the backlight chassis 53, and FIG. 7 is a plan view of the reflective sheet 41.

FIG. 1 is a partial perspective view showing a lamp clip 21 gripping a fluorescent lamp 51 and support units 11 supporting the reflective sheet 41. FIG. 2 is a two-view diagram consisting of a plan view of different members disposed on the backlight chassis 53 and a sectional view cut along line A1-A1′ in the plan view as seen from the direction of arrows. FIG. 3 is, like FIG. 2, a two-view diagram consisting of a plan view of different members disposed on the backlight chassis 53 and a sectional view cut along line B1-B1′ in the plan view as seen from the direction of arrows. For convenience' sake, in the sectional views in FIGS. 2 and 3, the diffuser sheet 43 is shown as well. Also for convenience' sake, lines A1-A1′ and B1-B1′ are shown in FIG. 1 as well.

The lamp clips 21 are members that grip the fluorescent lamps 51 and fix them to the backlight chassis 53, and as shown in FIG. 4 each lamp clip 21 includes a clip portion 22, a pillar portion 23, and a clip anchor portion 24.

The clip portion 22 is a member that grips the side face of a fluorescent lamp 51, which is bar-shaped (cylindrical, etc.). Accordingly, the clip portion 22 has the shape of a cylindrical pipe having a cut 22C formed in the side face for the gripping of the cylindrical fluorescent lamp 51. To enable the clip portion 22 to grip the fluorescent lamp 51, the inner diameter of the clip portion 22 is made slightly larger than the outer diameter of the fluorescent lamp 51.

The clip portion 22 has outward-bent portions 22P and 22P which form the edges of the cut 22C. The outward-bent portions 22P and 22P are increasingly apart from each other away from the inner-diameter center IC (see FIG. 3) of the clip portion 22. Thus, the width of the cut 22C (the interval between the outward-bent portions 22P and 22P) is increasingly large away from the inner-diameter center IC (see FIG. 3) of the clip portion 22.

The outward-bent portions 22P and 22P are formed of resin, and are thus elastic. Accordingly, when a fluorescent lamp 51 is pressed against them at the cut 22C, the outward-bent portions 22P and 22P come farther apart from each other owing to their elasticity. This allows the fluorescent lamp 51 to fit into the clip portion 22 easily.

Once the fluorescent lamp 51 fits into the clip portion 22, the outward-bent portions 22P and 22P, which have just had the cut 22C widened temporarily, restore their original state (the state in which they are not obstructed by the fluorescent lamp 51) owing to their elasticity. Now the outward-bent portions 22P and 22P come closer to each other, and press against the fluorescent lamp 51. Thus, the fluorescent lamp 51 is stably gripped so as not to come off the clip portion 22.

The pillar portion 23, at its tip end, supports the clip portion 22 and, at its base end, connects to the clip anchor portion 24.

The clip anchor portion 24 is, as shown in FIG. 6, a member that hooks on the edge of a hole (a chassis hole 53L) formed in the bottom face 53B of the backlight chassis 53. Thus, by hooking on the edge of the chassis hole 53L, the clip anchor portion 24 keeps the lamp clip 21 in fixed position not only in directions along the plane of the bottom face 53B but also in the direction rising from (such as perpendicular to) the bottom face 53B of the backlight chassis 53.

Next, the support units 11 will be described. The support units 11 serve to support the reflective sheet 41 while letting it sag from place to place, and also to support the optical sheet stack 42. As shown in FIG. 5, the support units 11 each include a shaft portion 12, a base portion 13, and a unit anchor portion 14.

The shaft portion 12 is a conic bar-like member tapering off toward its tip end 12T. The shaft portion 12, at its tip end 12T, supports the optical sheet stack 42. The shaft portion 12 further includes, at its base end 12B, a brim portion (a first supporting portion) 15 formed as a protrusion protruding from the side face 12S of the shaft portion 12 itself. The brim portion 15 is formed so as to surround the outer circumference of the shaft portion 12, and thus forms a ring-shaped disc. On this brim portion 15, the shaft portion 12 (and hence the support unit 11) supports the reflective sheet 41 (details will be discussed later).

The base portion 13 is a cylindrical bar-like member which supports the base end 12B of the shaft portion 12. As shown in FIG. 5, the size around the cylinder at the base portion 13 is smaller than the size around the outer circumference of the brim portion 15, which has the shape of a disc hollow at the center (the diameter of the base portion 13 about its pillar direction is smaller than the diameter of the brim portion 15). On the other hand, the size around the cylinder at the base portion 13 is approximately equal to the size around the shaft at the base end 12B of the shaft portion 12.

The unit anchor portion 14, like the clip anchor portion 24 included in the lamp clip 21, is a member that hooks on the edge of a hole (a chassis hole 53U; see FIG. 6) formed in the bottom face 53B of the backlight chassis 53. Thus, by hooking on the edge of the chassis hole 53U, the unit anchor portion 14 keeps the support unit 11 in fixed position not only in directions along the plane of the bottom face 53B but also in the direction rising from (such as perpendicular to) the bottom face 53B of the backlight chassis 53.

Next, the backlight chassis 53 will be described with reference to FIG. 6. The backlight chassis 53 has chassis holes 53L into which the clip anchor portions 24 of the lamp clips 21 are fitted and chassis holes 53U into which the unit anchor portions 14 of the support units 11 are fitted.

The chassis holes 53L are, for example, holes for the fitting of the lamp clips 21 which grip the fluorescent lamps 51 at their opposite ends. Accordingly, as will be seen in FIG. 6, where the shapes of the fluorescent lamps 51 overlapping the bottom face 53B of the backlight chassis 53 are indicated by broken lines (the reference sign for the fluorescent lamps 51 being used to identify their shapes as well), the chassis holes 53L are formed in divided rows at one and the other ends of the fluorescent lamps 51.

Thus, the fluorescent lamps 51 are, near their opposite ends, gripped by the lamp clips 21 and are thereby fitted to the backlight chassis 53. Here, the fluorescent lamps 51 are arranged in columns (side by side in X direction), and accordingly the chassis holes 53L are arranged in a matrix.

So that the support units 11 may not overlap the fluorescent lamps 51, the chassis holes 53U are formed at locations displaced from the chassis holes 53L, for example between adjacent fluorescent lamps 51. More specifically, a plurality of chassis holes 53U are formed between adjacent fluorescent lamps 51 in X direction, along the direction in which the fluorescent lamps 51 extend (Y direction). Thus, the chassis holes 53U too are arranged in a matrix (the outermost chassis holes 53B in X direction are not arranged between adjacent fluorescent lamps 51).

Next, the reflective sheet 41 will be described in detail with reference to FIG. 7. The reflective sheet 41 has two kinds of holes 41U and 41L and half-cut lines 41N formed by kiss-cutting.

The sheet holes 41U of the first kind are sheet holes 41U through which the shaft portions 12 of the support units 11 pass. What is particular about the sheet holes 41U is that they have such a size (diameter) as to permit the shaft portions 12 to pass through them but not the brim portions 15.

Thus, the support units 11 are, as shown in FIGS. 1 and 2, so designed that the shaft portions 12 pass through the reflective sheet 41 from its non-reflective surface 41V side and that the unit anchor portions 14 fit into the chassis holes 53U in the backlight chassis 53. Thus, the brim portions 15 support the edges of the sheet holes 41U, and keep the reflective sheet 41 apart from the bottom face 53B of the backlight chassis 53.

As shown in FIGS. 6 and 7, the number of sheet holes 41U is equal to the number of chassis holes 53U, and the sheet holes 41U and the chassis holes 53U are both arranged in a matrix.

However, when the interval WB between adjacent chassis holes 53U in X direction is compared with the interval WS between adjacent sheet holes 41U, the interval WS is greater than the interval WB. With this design, the parts of the reflective sheet 41 that are located between adjacent sheet holes 41U in X direction (the parts of the reflective sheet 41 each including the interval WU) tend to sag toward the backlight chassis 53 under self-weight (the rigidity of the reflective sheet 41 is comparatively low to allow it to sag, and is, for example, lower than the rigidity of the diffuser sheet 43).

Such sagging of the reflective sheet 41 is ensured by the half-cut lines 41N formed by kiss-cutting. The half-cut lines 41N extend in Y direction, and are arranged side by side in X direction as if dividing between the sheet holes 41U arranged in Y direction and the sheet holes 41L likewise arranged in Y direction. The half-cut lines 41N are formed by half-cutting from the reflective surface 41R side (that is, no cutting is done on the non-reflective surface 41V).

This ensures that, as shown in FIGS. 1 to 3, the parts of the reflective sheet 41 that are located between adjacent sheet holes 41U in X direction sag toward the backlight chassis 53 along the half-cut lines 41N so as to form troughs VG. Thus, it may be said that the half-cut lines 41N serve to bend the reflective sheet 41 along the boundaries between the parts of the reflective sheet 41 that are supported on the brim portions 15 and the parts of the reflective sheet 41 that sag toward the side faces 13S of the base portions 13 of the support units 11.

The half-cut lines 41N may be formed otherwise than by kiss-cutting; they may instead be formed by, for example, slit-cutting (perforation).

The sheet holes 41L of the second kind are sheet holes 41L that are formed at the troughs VG formed in the reflective sheet 41 (that is, the intervals produced as a result of groups of sheet holes 41U, each group consisting of sheet holes 41U arranged in Y direction, being arranged in X direction). These sheet holes 41L permit the clip anchor portions 24 of the lamp clips 21 to pass through them. What is particular about the sheet holes 41L is that they have such a size as to permit the clip anchor portions 24 to pass through them but not the base portions 13.

Thus, the lamp clips 21 are so designed that the clip anchor portions 24 pass through the reflective sheet 41 from its reflective surface 41R side and that the clip anchor portions 24 fit into the chassis holes 53L in the backlight chassis 53. Thus, the clip portions 22 of the lamp clips 21 are located above the reflective surface 41R of the reflective sheet 41, and the fluorescent lamps 51 are gripped in the clip portions 22.

The lamp clips 21, by being located above the reflective surface 41R, presses the reflective sheet 41. This is achieved in the following manner. First, the unit anchor portions 14 are fitted into the chassis hole 53U so that the support units 11 are kept in fixed position on the bottom face 53B of the backlight chassis 53. Next, the reflective sheet 41 is placed over the bottom face 53B of the backlight chassis 53, where now the support units 11 are arranged all across, with the non-reflective surface 41V of the reflective sheet 41 facing the bottom face 53B of the backlight chassis 53.

More specifically, the reflective sheet 41 is placed over the bottom face 53B of the backlight chassis 53 with the shaft portions 12 of the support units 11 passing through the sheet holes 41U in the reflective sheet 41. Then, since the interval (interval WS) between adjacent sheet holes 41U is greater than the interval (interval WB) between adjacent support units 11 in X direction, when the sheet holes 41U fit around the shaft portions 12 of the support units 11, a force acts on the parts of the reflective sheet 41 corresponding to the interval WS.

Then, those parts of the reflective sheet 41 sag along the half-cut lines 41N formed from the reflective surface 41R side. More specifically, those parts of the reflective sheet 41 sink toward the backlight chassis 53 so as to form troughs VG. In these troughs VG, the sheet holes 41L are formed.

Then, the clip anchor portions 24 of the lamp clips 21 are passed through the reflective sheet 41 from its reflective surface 41R side, and are then fitted into the chassis holes 53L in the backlight chassis 53. Now, the clip portions 22 of the lamp clips 21 are located above the reflective surface 41R of the reflective sheet 41, and then the fluorescent lamps 51 are gripped in the clip portions 22.

With this design, as shown in FIG. 2, the parts of the optical sheet stack 42 about right above the fluorescent lamps 51 (the regions of the optical sheet stack 42 that overlap the fluorescent lamps 51 in Z direction) are supplied with light (direct light) directly from the fluorescent lamps 51 without a detour via the reflective sheet 41 (see light L1).

On the other hand, the parts of the reflective sheet 41 that sag toward the side faces 13S of the base portions 13 are located by the side of the fluorescent lamps 51. Thus, the light reflected from those sagging parts of the reflective sheet 41 is supplied to the parts of the optical sheet stack 42 about right above the support units 11 (see light L2). More specifically, part of the light from the fluorescent lamp 51 strikes and is then reflected from the parts of the reflective sheet 41 that are located between adjacent support units 11 and sag to form troughs VG. The reflected light then travels toward the parts of the optical sheet stack 42 about right above the support units 11.

Then, on the plane of the optical sheet stack 42, both the regions overlapping the fluorescent lamps 51 and the regions overlapping the intervals between the fluorescent lamps 51 are supplied with light. Thus, uneven light distribution (visibility of the linear shapes of the lamp holders 52; a lamp image) resulting from excessive light being supplied to the parts overlapping the fluorescent lamps 51 on the plane of the optical sheet stack 42 is suppressed.

As described above, the support units 11, which make the reflective sheet 41 sag for the prevention of uneven light distribution, not only support the reflective sheet 41 but also support the optical sheet stack 42 (directly, the diffuser sheet 43). That is, on one hand, the support units 11, at their brim portions 15, support the reflective sheet 41, which has relatively low rigidity, to make it sag toward the side faces 13S of the base portions 13; on the other hand, the support units 11, at the tips of their shaft portions 12, support the diffuser sheet 43, which has relatively high rigidity.

In other words, it can be said that, here, the support units 11, which are generally provided to support the optical sheet stack 42 including the diffuser sheet 43, has been improved to include a new part (the brim portions 15) to support the reflective sheet 41. Accordingly, the backlight unit 69 does not need to be provided with a separate reflective member for supplying light to about right above the support units 11 in order to suppress uneven light distribution such as a lamp image. This reduces the cost of the backlight unit 69, and hence the cost of the liquid crystal display device 89.

Moreover, to make the reflective sheet 41 sag so as to enclose the fluorescent lamps 51, the support units 11 raise, at their brim portions 15, the edges of the sheet holes 41U in the reflective sheet 41. Thus, the support units 11 only touch parts of the reflective sheet 41 (the edges of the sheet holes 41U), and do not make planer contact across a large area; likewise, the lamp clips 21 only touch parts of the reflective sheet 41 (the edges of the sheet holes 41L), and do not make planer contact across a large area.

That is, the fixing of the reflective sheet 41 with respect to the bottom face 53B of the backlight chassis 53 is achieved by the contact of the lamp clips 21 with the bottom face 53B of the backlight chassis 53 via the reflective sheet 41 and the contact of the support units 11, which are fixed to the backlight chassis 53, with the reflective sheet 41. With this design, even when there is a change in the size of the reflective sheet 41 (due to variations in the dimensions of the reflective sheet 41, or temperature-induced contraction or the like of the reflective sheet 41), the reflective sheet 41 is surely fixed with respect to the bottom face 53B of the backlight chassis 53 (that is, various factors for variations in the reflective sheet 41 can be tolerated). In addition, the reflective sheet 41 is less prone to become wrinkled.

For example, in some designs, planar contact across a large area between the reflective sheet and the bottom face of the backlight chassis is exploited to fix the reflective sheet to the bottom face of the backlight chassis. In other designs, parts of the backlight chassis located between adjacent fluorescent lamps are raised, and the reflective sheet is fixed in close contact with those raised parts, so that the parts of the reflective sheet fixed in close contact function as a reflective member which supplies light to about right above the intervals between adjacent fluorescent lamps.

In these designs, if there is a change in the size of the reflective sheet, that makes it difficult to fix the reflective sheet with respect to the bottom face of the backlight chassis. In addition, the reflective sheet is prone to become wrinkled.

These inconveniences, however, are less likely to occur in a design where the fixing of the reflective sheet 41 with respect to the bottom face 53B of the backlight chassis 53 is achieved by local contact, namely the contact of the lamp clips 21 with the bottom face 53B of the backlight chassis 53 via the reflective sheet 41 and the contact between the support units 11 fixed to the backlight chassis 53 with the reflective sheet 41.

### Embodiment 2

Another embodiment (Embodiment 2) of the invention will be described below. Such members in Embodiment 2 as have similar functions to the corresponding members in Embodiment 1 will be identified by the same reference signs, and no overlapping description will be repeated.

In Embodiment 1, the reflective sheet 41 includes the sheet holes 41U, and the support units 11, by sticking the shaft portions 12 through sheet holes 41U, support, at the tip ends 12T of the shaft portions 12, the optical sheet stack 42 including the diffuser sheet 43. On the other hand, the support units 11, at the brim portions 15, which are parts of the shaft portions 12, support the edges of the sheet holes 41U and thereby support the reflective sheet 41.

Instead, the support units 11 may, at parts of the shaft portions 12 other than the brim portions 15, support the reflective sheet 41. Specifically, the support units 11 can, at the tip ends 12T of the shaft portions 12, support the reflective sheet 41. Such a design will now be described with reference to FIGS. 8 to 10.

FIG. 8 is a perspective view of a support unit 11. FIG. 9 is a two-view diagram showing how the support unit 11 in FIG. 8 supports the reflective sheet 41 (the two views are presented in a similar manner as in FIG. 2).

As shown in FIG. 8, the support unit 11 here has no brim portion 15. As shown in FIG. 9, the support units 11, at the tip ends 12T of their shaft portions 12, support the reflective sheet 41 from its non-reflective surface 41V side, and in addition, via the reflective sheet 41, support the diffuser sheet 43 as well. Also with this design, the support units 11 support the reflective sheet 41, which has comparatively low rigidity, and makes it sag toward the side faces 13S of the base portions 13. In addition, the support units 11, at the tip ends of their shaft portions 12, also support the diffuser sheet 43, which has relatively high rigidity.

Thus, also with this design, as shown in FIG. 9, the parts of the optical sheet stack 42 located about right above the fluorescent lamps 51 are supplied with light (direct light L1) from the fluorescent lamps 51 directly without a detour via the reflective sheet 41, and the parts of the optical sheet stack 42 about right above the support units 11 are supplied with reflected light L2 from the fluorescent lamps 51 via the reflective sheet 41.

Then, on the plane of the optical sheet stack 42, both the regions overlapping the fluorescent lamps 51 and the regions overlapping the intervals between the fluorescent lamps 51 are supplied with light, and thus uneven light distribution is suppressed.

In a case where, as shown in FIG. 9, the support units 11, at the tip ends 12T of the shaft portions 12, support the reflective sheet 41, the parts of the reflective sheet 41 that sag toward the side faces 13S of the base portions 13 of the support units 11 make contact with the diffuser sheet 43, and spaces are formed that are surrounded by the diffuser sheet 43 and the reflective sheet 41. When the fluorescent lamps 51 as light sources are disposed in those spaces, the light from one fluorescent lamp 51 is less likely to reach the space in which another fluorescent lamp 51 is housed.

Accordingly, when this phenomenon is exploited, it is preferable that the backlight unit 69 be one in which, as shown in FIG. 10, a plurality of LEDs (point light sources, light-emitting elements) 55 are arranged all across in a matrix. The reason is that, with such a backlight unit 69, the emitted light can be controlled for each LED 55, and thus it is possible to partly illuminate the display region of the liquid crystal display device 89 (a backlight unit 79 of this type is called a backlight unit 79 of an active area type).

Then, to partly illuminate the display region of the liquid crystal display device 89 more accurately, it is preferable that the light from one LED 55 not reach the region illuminated by another LED 55. Thus, in a backlight unit 69 of an active area type, it is preferable that, with support units 11 like that shown in FIG. 8, the reflective sheet 41 be raised to divide the regions illuminated by the light of the individual LEDs 55.

In such a backlight unit 69, the LEDs 55 are mounted, through the sheet holes 41L, on a mounting circuit board 56 covered with the reflective sheet 41. Thus, the LEDs 55 directly press the reflective sheet 41 (in the backlight unit 69 of Embodiment 1, the fluorescent lamps 51 indirectly press the reflective sheet 41 via the lamp clips 21.

### Other Embodiments

It should be understood that the present invention is not limited by the embodiments described above and accommodate many modifications and variations without departing from the spirit of the invention.

For example, the shape of the support unit 11 is not limited to that shown in FIG. 5 where part of the shaft portion 12 is formed into a brim portion 15. For example, as shown in FIG. 11, the top face 13U of the base portion 13 supporting the base end 12B of the shaft portion 12 may have a larger size than the outer circumference of the base end 12B of the shaft portion 12. With this design, the top face 13U (a fixing portion), which is part of the base portion 13 and which keeps the base end 12B of the shaft portion 12 in fixed position, can support the edge of the sheet hole 41U in the reflective sheet 41.

The outer circumference does not necessarily have to be circular like the brim portion 15 of the shaft portion 12 in FIG. 5 and the top face 13U of the base portion 13 in FIG. 11. For example, as shown in FIG. 12, part of the shaft portion 12 near its base end 12B may be formed into a block-shaped projection 16 (a first supporting portion).

In short, it is at least necessary that, when the tip end 12T of the shaft portion 12 has passed through the sheet hole 41U in the reflective sheet 41 and the base end 12B is now about to pass through the sheet hole 41U, a brim portion 15 or a projection portion 16 formed as a protrusion protruding from the side face 12S of the shaft portion 12 support the edge of the sheet hole 41U.

In the above description, the brim portion 15 and the projection portion 16 are formed by part of the shaft portion 12 near its base end 12B. This should not be understood as a limitation. For example, the brim portion 15 and the projection portion 16 may be formed of part of the base portion 13 near its top face 13U. In short, the brim portion 15 and the projection portion 16 may instead be formed as a protrusion protruding from the side face 13S of the base portion 13 (the brim portion 15 and the projection portion 16 so formed are called a second supporting portion).

In the support unit 11, the shaft portion 12 and the base portion 13 may be formed as a single piece together, or as separate pieces to be combined together. The brim portion 15 or the projection portion 16 may be formed as a single piece with, or a separate piece to be combined with, the shaft portion 12. Likewise, the brim portion 15 or the projection portion 16 may be formed as a single piece with, or a separate piece to be combined with, the base portion 13.

The support unit 11 may be composed of, as shown in FIG. 13, a base portion 13 that extends linearly like the fluorescent lamp 51 and a plurality of shaft portions 12 that are fitted to it. This design helps reduce the number of components, and thus facilitates the production of the backlight unit 69 (and hence the liquid crystal display device 89).

As shown in FIGS. 11 and 13, the base portion 13 may be increasingly thick toward its bottom face (bottom end) 13B opposite from its top face (end) 13U supporting the shaft portion 12. With this design, the center of gravity of the support unit 11 is closer to the bottom face 53B of the backlight chassis 53 (that is, the center of gravity of the support unit 11 is closer to the bottom face 13B of the base portion 13), and thus the optical sheet stack 42 and the reflective sheet 41 can be supported more stably.

The shaft portion 12 of the support unit 11 may be increasingly thin toward its tip end 12T. With this design, when the user views the liquid crystal display panel 79 from the front, the tip end 12T of the shaft portion 12 is less visible.

Although in the above description the shaft portion 12 of the support unit 11 has a circular cross-sectional shape in XY directions, this should not be understood as a limitation. For example, the shaft portion 12 may be formed in the shape of a rectangular prism or the like with a polygonal, such as rectangular, cross-sectional shape. The shape of the sheet hole 41U through which the shaft portion 12 is passed is not limited to circular but may instead be polygonal.

### LIST OF REFERENCE SIGNS

11 support unit
12 shaft portion
12T shaft portion's tip end
12S shaft portion's side face
12B shaft portion's base end
13 base portion
13U base portion's top face
13S base portion's side face
13B base portion's bottom face
14 unit anchor portion
15 brim portion (first supporting portion, second supporting portion)
16 projection portion (first supporting portion, second supporting portion)
21 lamp clip
22 clip portion
23 pillar portion
24 clip anchor portion
41 reflective sheet
41R reflective sheet's reflective surface
41V reflective sheet's non-reflective surface
41N half-cut line
41U support unit sheet hole
41L lamp clip sheet hole
42 optical sheet stack
43 diffuser sheet
51 fluorescent lamp (linear light source, light source)
53 backlight chassis (chassis)
53U support unit chassis hole
53L lamp clip chassis hole
55 LED (linear light source, light source)
69 backlight unit (illuminating device)
79 liquid crystal display panel (display panel)
89 liquid crystal display device (display device)

1. A supporting unit for supporting a sheet, comprising:
a shaft portion; and
a base portion supporting the shaft portion,
wherein
a part of the shaft portion or a part of the base portion supports, out of a first and a second said sheet, the first said sheet having lower rigidity so as to let the first said sheet sag toward a side face of the base portion, and
a tip end of the shaft portion supports, out of the first and the second said sheet, the second said sheet having higher rigidity.

2. The supporting unit according to claim 1,
wherein
when the first said sheet includes a hole,
the shaft portion sticks through the hole in the first said sheet so as to support, at the tip end, the second said sheet, and
the part of the shaft portion or the part of the base portion supports an edge of the hole so as to support the first said sheet.

3. The supporting unit according to claim 1,
wherein the part of the shaft portion is the tip end.

4. The supporting unit according to claim 2,
wherein the part of the shaft portion is a first supporting portion which is formed as a protrusion that protrudes from a side face of the shaft portion.

5. The supporting unit according to claim 2,
wherein the part of the base portion is a second supporting portion which is formed as a protrusion that protrudes from the side face of the base portion.

6. The supporting unit according to claim 2,
wherein the part of the base portion is a fixing portion which supports a base end of the shaft portion and which is larger than an outer circumference of the base end.

7. The supporting unit according to claim 1,
wherein the shaft portion is increasingly thin toward the tip end.

8. The supporting unit according to claim 1,
wherein the base portion supports a plurality of said shaft portion.

9. The supporting unit according to claim 1,
wherein the base portion is increasingly thick toward a bottom end thereof opposite from an end thereof supporting the shaft portion.

10. A sheet set comprising:
the supporting unit according to claim 1;
as the first said sheet, a reflective sheet which reflects received light; and
as the second said sheet, an optical sheet which transmits received light.

11. The sheet set according to claim 10,
wherein the reflective sheet is subjected to processing to allow the reflective sheet to bend along a boundary between a part of the reflective sheet that is supported by the part of the shaft portion or the part of the base portion and a part of the reflective sheet that sags toward the side face of the base portion.

12. The sheet set according to claim 11,
wherein the processing is kiss-cutting or slitting.

13. An illuminating device comprising:
the sheet set according to claim 10;
a chassis to a bottom face of which the base portion of the supporting unit is fitted; and
a light source provided between the first and second said sheets to emit light.

14. The illuminating device according to claim 13,
wherein the light source is a linear light source or a point light source.

15. A display device comprising:
the illuminating device according to claim 13; and
a display panel to receive light from the illuminating device.
